(19) United States
(12) Patent Application Publication
(10) Pub. No.: US 2005/0244803 A1
(43) Pub. Date: Nov. 3, 2005

(54) Classroom polling system

(75) Inventors: Benny R. Brown, Urbana, IL (US); Mats A. Selen, Urbana, IL (US); Timothy J. Stelzer, Urbana, IL (US)

Correspondence Address: BANNER & WITCOFF, LTD., TEN SOUTH WACKER DRIVE, SUITE 3000, CHICAGO, IL, 60606, US

(73) Assignee: Interactive Learning Technologies, LLC, Urbana, IL (US)

(21) Appl. No.: 11/026,973

(22) Filed: Dec. 30, 2004

Related U.S. Application Data
(60) Provisional application No. 60/566,059, filed on Apr. 28, 2004.

(51) Int. Cl. G09B 3/00

(52) U.S. Cl. 434/350

(57) ABSTRACT

The present invention provides systems and methods for an instructor to periodically poll students to ensure that educational material being presented is being comprehended by students. The systems and methods may be utilized at large learning institutions such as universities as the system supports numerous users. The systems and methods provide two-way communication and allow for feedback from students at a reasonable cost.

### FIELD OF THE INVENTION

Aspects of the present invention relate generally to a classroom polling system to assist students and instructors in a classroom environment. More specifically, aspects of the present invention provide methods and systems for an instructor to periodically poll students to ensure that educational material being presented is being comprehended by students.

### BACKGROUND

The interaction between a student and a teacher is a key component of learning. In small classrooms where the instructor can wander from desk to desk among a handful of students, the required interaction is not difficult to achieve, but in large lecture situations, such interactions are practically impossible due to the sheer number of students involved, (typically hundreds, possibly thousands) and the theater style layout typical of lecture halls.

Education research has shown that pausing a lecture being presented to a class every five to ten minutes and asking students to vote on an answer to a conceptual question improves both learning and retention. Many techniques have been successfully used to gather student votes during such activities, from a simple show of hands to hard-wired buttons attached to every seat. The former has the advantage of low cost and simplicity, but the distinct disadvantages that a student's reply is not private and that the instructor only gets a sense of what the class is thinking, because exact record-keeping is not practical. The latter approach has the advantage of anonymity and data collection, but is typically very expensive and difficult to maintain.

Another technique that is used to gather student votes includes utilizing wireless systems which utilize remotes and unique ID's for each student. The remotes and unique ID's are used to transmit the student's vote to base units located in the classroom which may be interfaced to a host computer system. The current wireless systems utilizing wireless remotes, however, have several drawbacks.

Current wireless remotes include both infrared remotes and radio frequency remotes. Infrared remotes only transmit one way, from student to instructor, and do not allow a student to receive feedback on the remote as to whether their vote was received by the instructor. In addition, infrared systems have rather low bandwidth, the result of which is a single base unit used to receive the votes from the infrared remotes can only receive signals from a limited number of student units, approximately 50. Furthermore, infrared remotes have a limited transmission range which is not practical for large classes, as many receivers would need to be strategically mounted around the whole room. This would significantly drive up the base unit infrastructure and usually means that a permanent installation of the receiver hardware is needed. Finally, infrared systems are prone to interference from fluorescent lighting sources.

Current radio frequency (RF) wireless systems are too expensive for use in a classroom environment. In addition, current radio frequency systems which utilize RF remotes can only support up to 2400 unique remote units with a single base unit. As only 2400 remotes can be supported by a single base, the systems are not practical for learning institutions where the same system may be used by several classes and consequently by many thousands of students simultaneously.

Therefore, there is a need in the art, for a system which provides support for numerous users in settings such as universities. The system should provide two-way communication and allow for feedback to students at a reasonable cost.

### BRIEF DESCRIPTION OF THE DRAWINGS

Aspects of the present invention are described with respect to the accompanying figures, in which like reference numerals identify like elements, and in which:

FIG. 1 shows a functional block diagram of various components of a radio frequency polling system of the present invention;

FIG. 2 shows a conventional networked computer system that can be used to implement various aspects of the invention;

FIG. 3 shows components of a base unit and remote unit in accordance with various aspects of the present invention;

FIG. 4 shows a transmission timeline in accordance with various aspects of the present invention;

FIG. 5 shows another transmission timeline in accordance with an additional embodiment of the present invention;

FIG. 6 depicts a flow diagram of an attendance protocol in accordance with an aspect of the present invention;

FIGS. 7a, 7b, and 7c depict additional flow diagrams of an attendance protocol in accordance with an aspect of the present invention;

FIG. 8 depicts an alternative flow diagram of an attendance protocol in accordance with another aspect of the present invention;

FIG. 9 depicts a flow diagram of a time-slice voting protocol in accordance with an aspect of the present invention;

FIGS. 10a and 10b depict additional flow diagrams of a time-slice voting protocol in accordance with an aspect of the present invention;

FIG. 11 depicts a flow diagram of an alternative time-slice voting protocol in accordance with another aspect of the present invention; and

FIG. 12 depicts an additional flow diagram of an additional time-slice voting protocol in accordance with an aspect of the present invention.

FIG. 13 depicts an additional flow diagram of an additional communications protocol in accordance with an aspect of the present invention.

FIGS. 14a, 14b, and 14c illustrate the bits transmitted to and from remote units in accordance with various aspects of the present invention.

### DETAILED DESCRIPTION

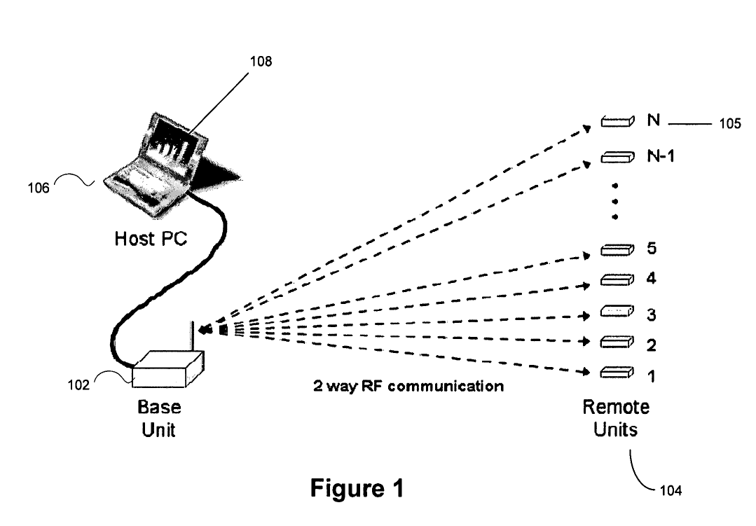

FIG. 1 illustrates a functional block diagram of various components of a radio frequency polling system of the present invention. In FIG. 1, a base unit (BU) 102 communicates with remote units (RU) 104 utilizing two-way radio frequency communications. The number N 105 of remote units 104 can be expanded to accommodate the number of users of the system.

A host personal computer 106 may be communicatively coupled to base unit 102. The host personal computer 106 includes a processing unit, memory, and drives such as a hard drive to provide nonvolatile storage of computer readable instructions. In addition, the host personal computer includes a keyboard or other input device for user input.

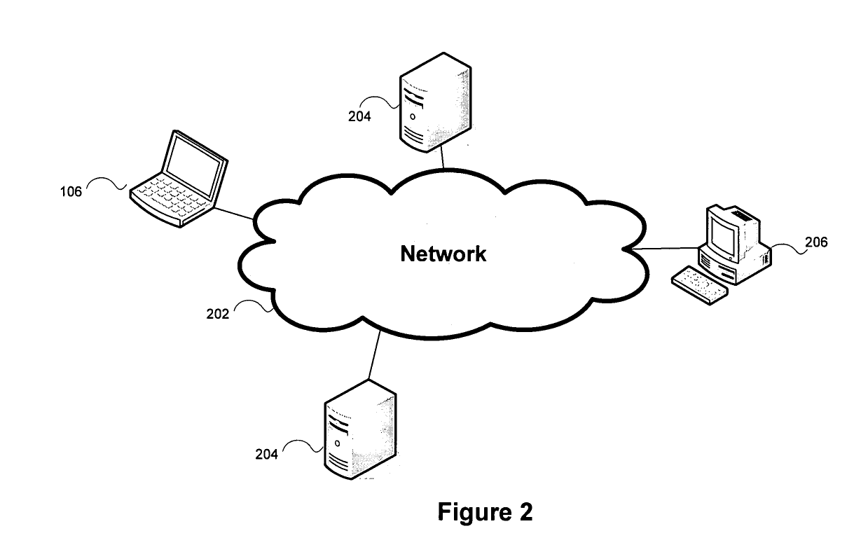

The host personal computer 106 may operate in a networked environment using logical connections to one or more remote computers as shown in FIG. 2. The host computer 106 may communicate through a network 202 to a server 204 or other remote computers such as computer 206. The network 202 may comprise a local area network (LAN) and a wide area network (WAN) 113.

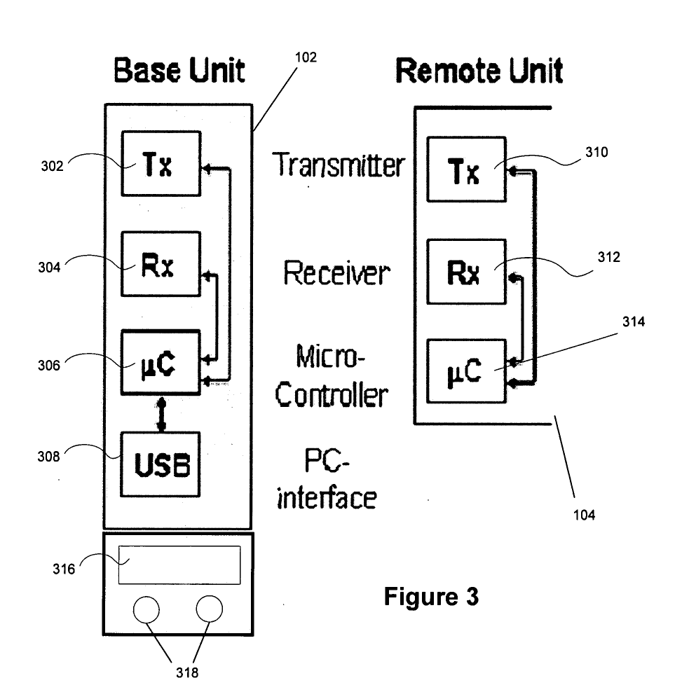

FIG. 3 illustrates in more detail a base unit 102 and a remote unit 104. Base unit 102 may comprise a transmitter 302, a receiver 304, a microcontroller 306, and a USB port 308. The transmitter 302 of base unit 102 is a radio frequency transmitter for transmitting data to remote units 104. The receiver 304 of base unit 102 may receive radio frequency transmissions from remote units 104. The microcontroller 306 of base unit 102 may implement commands received from host computer 106 and support received and transmitted data to and from base unit 102. Base unit 102 may also comprise a Universal Serial Port (USB) 308 to connect base unit 102 to host personal computer 106. Those skilled in the art will realize that base unit 102 may be communicatively coupled to host computer 106 in numerous ways and the use of a USB port is only illustrative and not intended to be limiting. Base unit 102 may be constantly listening for commands to be issued from the host computer 106 via the USB port 308. Command cycles for the system may be initiated from a control program (CP) 108 running on host computer 106.

The base unit 102 may also comprise a liquid crystal display (LCD) display 316 for displaying information to a user of the base unit. For example, the information displayed might include results of a student vote. One skilled in the art will appreciate that other display types may be substituted for the LCD display. Furthermore, the base unit may also comprise buttons 318 for inputting data into said base unit for controlling the operation of said base unit. For example, the buttons could be used to command the base unit to start and/or stop the voting process.

Similar to base unit 102, remote units 104 may also include a transmitter 310, a receiver 312, and a microcontroller 314. The transmitter 310 of remote unit 104 may include a radio frequency transmitter for transmitting data to base unit 102. The receiver 312 of remote unit 104 receives radio frequency transmissions from base unit 102. The microcontroller 314 of remote unit 104 may implement commands received from a base unit 102 and support received and transmitted data to and from remote unit 104.

The following description will be discussed with the use of an example to illustrate an aspect of the present invention in which the polling system may be used to take attendance during a lecture given at a learning institution such as a university.

At the beginning of each lecture, and periodically throughout the lecture, a control program 108 running on host computer 106 may take class attendance. The control program may access a database having the names of the students registered to attend the lecture in a list, such as a class roster. The database may, for each registered student, contain a unique ID number for the remote units 104 possessed by each student.

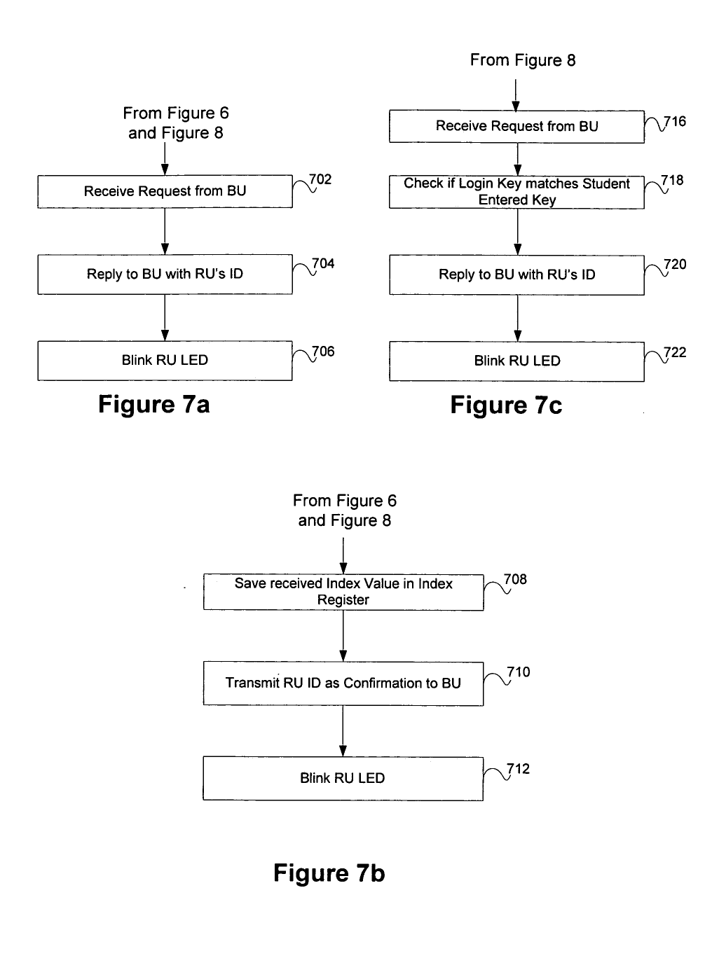

FIG. 6 depicts a flow diagram of a first attendance protocol in accordance with an aspect of the present invention. In FIG. 6 at step 602, an index counter of control program 108 may be set to zero. The index number may be used to track the number of remote units in the system. In step 604, a first identification number (ID) of a first remote unit is located in a class list by control program 108. The class list may be located in a database accessed by control program 108. The class list may identify the students who have properly registered and are therefore eligible to attend the classroom lecture.

Next in step 606, the control program 108 transmits the ID of the first remote unit which will be named remote unit number one to base unit 102. Along with the ID of the first remote unit, control program 108 also transmits a “request” command to base unit 102.

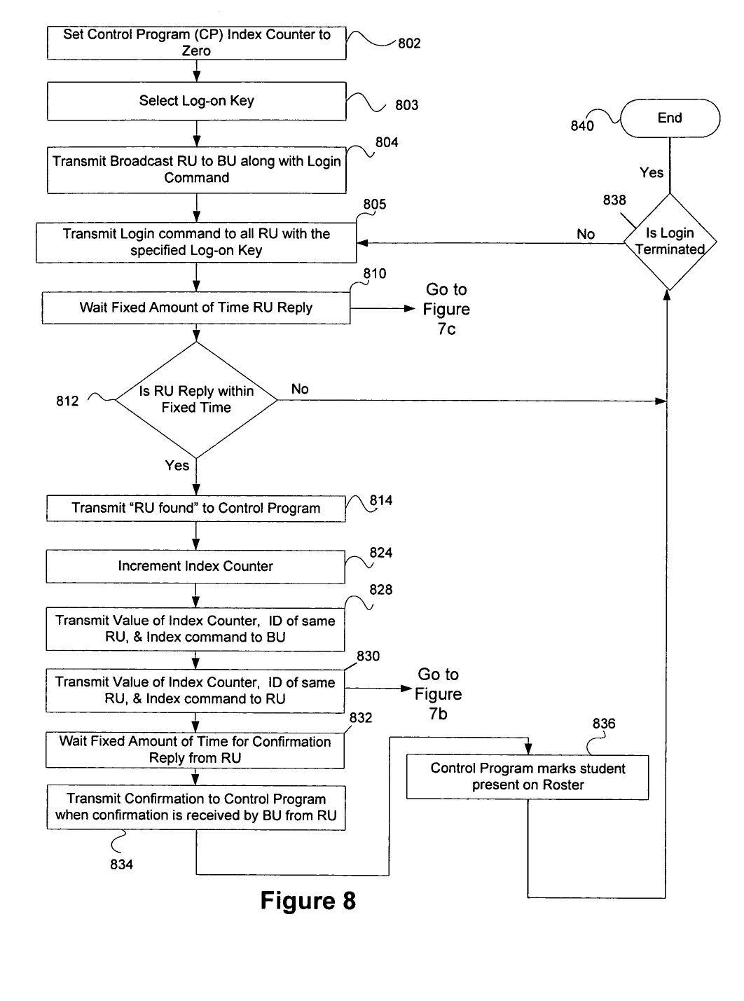

Upon receiving the ID of the first remote unit and the “request” command, the base unit 102 forwards the “request” command with the specified ID to remote unit 104, as indicated in step 608. When the remote unit 104 receives the “request” command (step 702 of FIG. 7a), remote unit 104 replies to the base unit 102 with remote unit's identification number (step 704 of FIG. 7a). In step 706 (FIG. 7a), remote unit 104 flashes a LED on its housing to indicate to a student that the remote unit 104 has transmitted information to base unit 102.

Base unit 102 may wait a fixed amount of time for the remote unit 104 to respond as indicated in step 610. In step 612, control program 108 determines if remote unit 104 responded to the “request” command within the fixed amount of time. If in step 612, remote unit 104 responds to the “request” command within the fixed amount of time, then base unit 102 may transmit a message such as “RU found” back to control program 108 in step 614. Those skilled in the art will realize that many different messages may be transmitted to control program 108 to indicate that remote unit 104 has been found.

If in step 616 remote unit 104 does not respond to the “request” command within the fixed amount of time, then base unit 102 may transmit a message “RU not found” back the control program 108 in step 616 via base unit 102. Additionally, if remote unit 104 does not respond in the fixed amount of time, control program 108 may check to see if a class list is completed in step 618. If the class list is completed, the attendance protocol ends at step 620. If the class list is not completed, then control program 108 may find the ID of the next remote unit 104 in step 622 and repeat the process in step 606.

When the message “RU found” is transmitted to control program 108, an index counter may be incremented in step 624. The incremented index counter may be transmitted to base unit 102 in step 628 along with the ID of the same remote unit. Additionally in step 628, an “index” command may be forwarded to base unit 102.

In response to the receipt of the incremented index counter, ID of remote unit, and “index” command, base unit 102 may transmit these items to remote unit 104 as shown in step 630. On receipt of the incremented index counter, ID of remote unit, and “index” command, remote unit 104 may save the received index value in an index register at step 708 (FIG. 7b). After saving the index value, remote unit 104 may transmit the ID of remote unit 104 back to the base unit 102 as confirmation of the information being received in step 710. In step 712, remote unit 104 may flash an LED on its housing to indicate to a student that remote unit 104 has transmitted information to the base unit 102.

In step 632, base unit 102 waits a fixed amount of time to receive confirmation back from remote unit 104 that the information transmitted was received. When base unit 102 receives confirmation that the information was received by remote unit 104, then base unit 102 forwards the information back to control program 108 in step 634.

After receiving the information from base unit 102, control program 108 marks the student as present at the lecture in step 636. Next, control program 108 checks to see if the class list is completed in step 618. If the class list is completed, the attendance protocol ends at step 620. If the class list is not completed, then control program 108 finds the ID of the next remote unit 104 in step 622 and control returns to step 606 to repeat the process. Once the entire class list is completed, attendance for the lecture has been taken.

A further aspect of the present invention is now discussed pertaining to an alternative method in which the polling system may be used to take attendance during a lecture given at a learning institution such as a university.

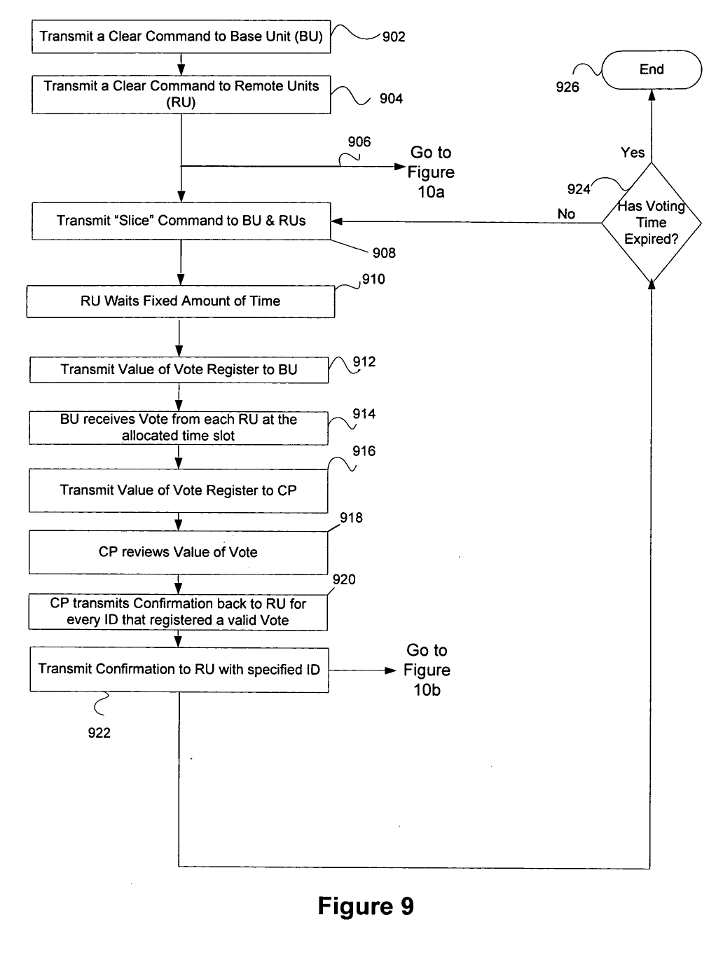

FIG. 8 depicts a flow diagram of a second attendance protocol in accordance with an aspect of the present invention. In FIG. 8 at step 802, an index counter of control program 108 may be set to zero. The index number may be used to track the number of remote units in the system. In step 803, control program 108 may select a log-on key. Next, in step 804, control program 108 transmits a log-on-key command to the base unit 102. Upon receipt of the “login” command the base unit 102 may transmit the “login” command to all remote units 104 with the specified login key, as shown in step 805.

Those skilled in the art will realize that microcontroller 306 of base unit 102 may also perform some of the steps of host computer 106 as control program 108 may be comprised of various modules running on both host computer 106 and the microcontroller 306 of base unit 102.

In step 716 of FIG. 7c, the remote units 104 receive the “login” command transmitted by base unit 102. Upon receipt of the “login” command, remote units 104 check to see if the login key matches a key entered by a student as shown in step 718 of FIG. 7c. Remote unit 104 replies to the base unit 102 with the remote unit's ID in step 720 of FIG. 7c. In step 722 of FIG. 7c, remote unit 104 may flash an LED on its housing to indicate to a student that the remote unit 104 has transmitted information to base unit 102.

In step 810, base unit 102 may wait a fixed amount of time for the remote unit 104 to respond. In step 812, control program 108 determines if the remote unit 104 responded to the “login” command within the fixed amount of time. If in step 812, remote unit 104 responds to the “login” command within the fixed amount of time, then base unit 102 may transmit a message such as “RU found” back to control program 108 in step 814. Those skilled in the art will realize that many different messages may be transmitted to control program 108 to indicate that the remote unit has been found.

If in step 812, remote unit 104 does not respond to the “login” command within the fixed time, then base unit 102 may check to see of the control program 108 in step 838 has terminated the attendance procedure. If control program 108 has terminated the attendance procedure then the attendance procedure may end at step 840. However, if the login or attendance procedure was not terminated by control program 108 then base unit 102 may transmit another login message to remote units 104 to see if any new units have logged in as show in step 805. Those skilled in the art will realize that control program 108 may terminate the attendance or login procedure for various reasons which may include instructor input or the beginning of a classroom lecture.

If the message “RU found” is transmitted to the control program 108, the index counter may be incremented in step 824. The incremented index counter may be transmitted to base unit 102 in step 828 along with the ID of the same remote unit. Additionally in step 828, an “Index” command may be forwarded to base unit 102.

In response to the receipt of the incremented index counter, ID of remote unit, and “Index” command, the base unit 102 may transmit these items to the remote unit 104 as shown in step 830. On receipt of the incremented index counter, ID of remote unit, and “Index” command, remote unit 104 may save the received index value in an index register at step 708 of FIG. 7b. After saving the index value, remote unit 104 may transmit the ID of remote unit 104 back to the base unit 102 as confirmation of the information being received in step 710 of FIG. 7b. In step 712 of FIG. 7b, remote unit 104 may flash an LED on its housing to indicate to a student that the remote unit 104 has transmitted information to base unit 102.

In step 832, base unit 102 may wait a fixed amount of time to receive confirmation back from the remote unit 104 that the information transmitted was received. When base unit 102 receives confirmation that the information was received by remote unit 104, then base unit 102 may forward the information back to control program 108 in step 834.

Control program 108 after receiving the information from base unit 102 marks the student as present at the lecture in step 836. In step 838, base unit 102 may check to see if the control program 108 has terminated the attendance procedure. If the control program 108 has terminated the attendance procedure then the attendance procedure may end at step 840. However, if the login or attendance procedure was not terminated by control program 108 then the base unit 102 may transmit another login message to the remote units 104 to see if any new units have logged in as show in step 805. In this manner attendance may be taken throughout entire classroom lecture.

Now that attendance may have been taken for the lecture, the following description will discuss another aspect of the invention which includes voting by students on questions asked by the instructor.

As an example, an instructor may ask a class a multiple choice question whose possible answers are labeled “A” through “E”, corresponding to the buttons on each student's remote unit 104. The students may be told that they have two minutes to decide which answer they like best and that they can push the button corresponding to that answer any time in the two minute time window. Those skilled in the art will realize that the time for response may be determined by the instructor and that various different time values may be utilized.

Using a graphical user interface (GUI) on the host computer 106, the instructor may instruct control program 108 to start the vote-gathering process. The control program 108, via base unit 102 may initialize remote units 104 for voting. The present invention may retrieve votes from a student using at least four possible protocols in accordance with various aspects of the present invention. Each of the four protocols are discussed below.

In each of the four protocols, control program 108 may set up a transaction sequence with remotes units 104. The control program 108, after setting up the transaction sequence with the remote units may go into a listening and timing mode in which a vote from each remote unit 104 is received in a pre-determined order determined by the remote unit's index number. This may provide a very efficient use of bandwidth as arrival of a remote unit's vote packet at the base unit 102 contains information about the vote (the content of the received bit packet) as well as the ID of the sending remote unit (the arrival time of the received bit packet), hence the bit packets are much shorter than in regular handshake type transactions because the remote unit ID does not need to be included.

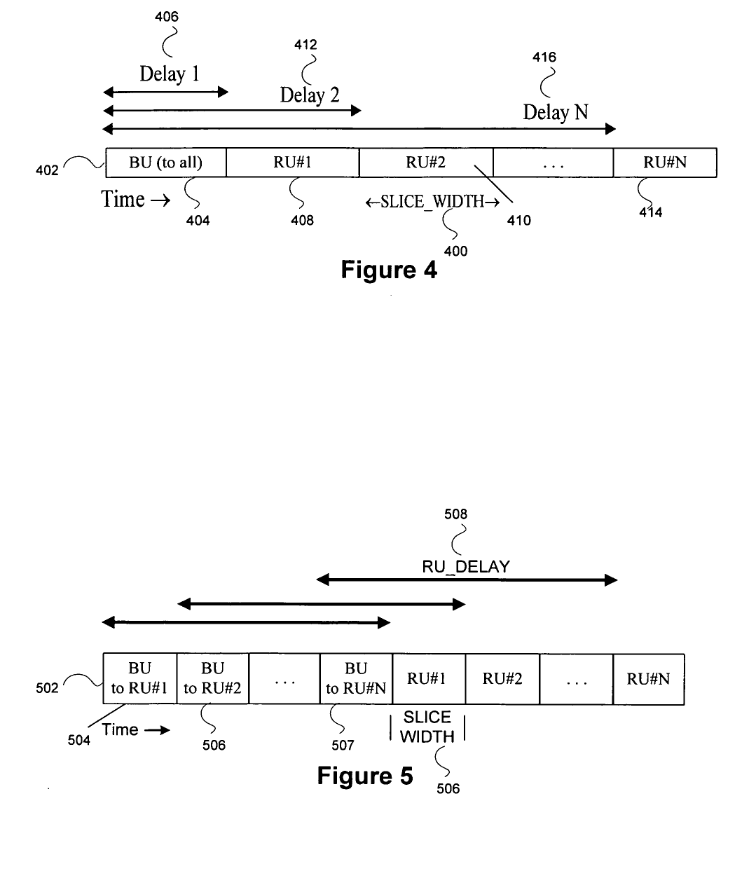

FIG. 4 depicts a timeline for a time-slice voting protocol in accordance with an aspect of the present invention. Referring to FIG. 4, in a classroom there may be N active students each having a remote unit 104. The attendance procedures discussed above may ensure that each such remote unit 104 is assigned an index number which may be an integer value between 1 and N.

During attendance, a control program 108 may assemble a list that correlates the index numbers with the actual ID of remote unit 104. Each of the remote units 104 may store its own unique index number in memory. Base unit 102 and each of the remote units 104 may also be aware of a predetermined constant SLICE_WIDTH 400. The SLICE_WIDTH 400 may be a length of time allotted to each remote unit 104 to send the remote unit's voting information to base unit 102. The SLICE_WIDTH 400 may provide enough information for each of the remote units 104 and base unit 102 to know exactly when to transmit or receive information from each student.

The transmission timeline 402 of FIG. 4 may indicate when either remote units 104 or base unit 102 are transmitting data as a function of time during the voting operation. For example, the process may begin when base unit 102 transmits a start signal 404 to all of the remote units 104 simultaneously. The start time for transmission 408 for a first remote unit 104 may be the first remote units index number multiplied by SLICE_WIDTH 400 as indicated in FIG. 4.

Each of the remote units 104 may use its index value to initialize a “Delay” counter to a value which, when decremented to zero, may correspond to the time at the beginning of its allocated transmission window. For example, a first remote unit 102 may have a first delay counter. The amount of time the first delay counter delays transmission of data from the first remote unit to the base station 102 may be represented by “Delay1” 406 in FIG. 4. After expiration of “Delay1” 406, the first remote unit 104 may then begin transmission of its voting register. Because each remote unit may have its own unique index value, the net result may be that only one remote unit is transmitting at a time and the order of the transmission discloses to base unit 102 the ID of the sending remote unit. Similar to the first remote unit, a second remote unit “RU2” may not begin transmission of its voting register until the end of a “Delay2” 412 time period. The process of transmission may continue until a remote unit “RU#N” 414 transmits its voting register after completion of a “DelayN” 416 time period.

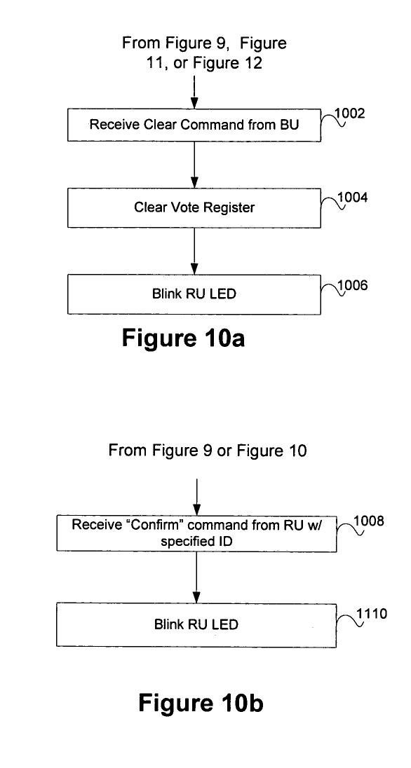

FIG. 9 depicts a flow diagram of a time-slice voting protocol of FIG. 4. In FIG. 9, a control program 108 may transmit a “clear” command to base unit 102 in step 902. Upon receipt of the “clear” command, a base unit 102 in step 904 may transmit to all of the remote units 104 simultaneously the “clear” command.

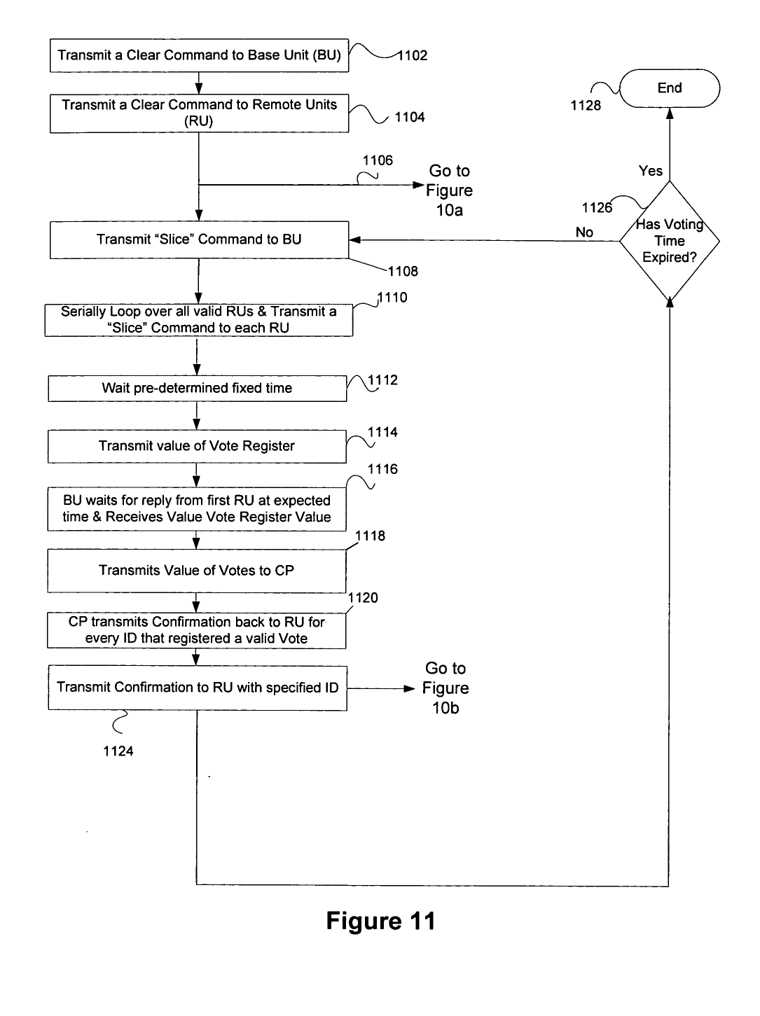

Upon receipt of the “clear” command at each of the remote units 104 (step 1002 FIG. 10a), the remote units 104 may clear their vote registers (step 1004). Each of the remote units 104 may flash an LED on its housing to indicate to a student that the remote units 104 have received a command from the base unit 102 (step 1006).

In step 908, control program 108 may transmit a “Slice” command to base unit 102. Base unit 102, in response to the “Slice” command in step 908 may transmit to all of the remote units 104 simultaneously. On receipt of the “Slice” command, each of the remote units 104 may wait a fixed amount of time before sending the contents of their voting register (step 910). The amount of waiting time or delay time may be the value of the remote units index number times SLICE_WIDTH 400.

In step 912, when the delay time has expired for a remote unit 104, the remote unit 104 may transmit the value of its vote register to base unit 102. Base unit 102 in step 914 listens for a time SLICE_WIDTH 400 for each remote unit 104 on a class list. The base unit 102 receives the vote from each of the remote units 104 during the allocated time slice and in step 916 transmits the information to control program 108.

In step 918, control program 108 reviews the votes and in step 920 transmits a “Confirm” command back to base unit 102 for each remote unit 104 that registered a valid vote. Base unit 102 in step 922 transmits to the “Confirm” command to remote units 104.

Upon receipt of the “Confirm” command by a remote unit 104 in step 1008 in FIG. 10b, the remote unit 104 flashes an LED to indicate to the student that their vote has been received. In step 924, the control program 108 determines whether the voting time has expired. If the voting time has expired then voting is ended (step 926). However, if the voting time has not expired, then the process continues in step 908.

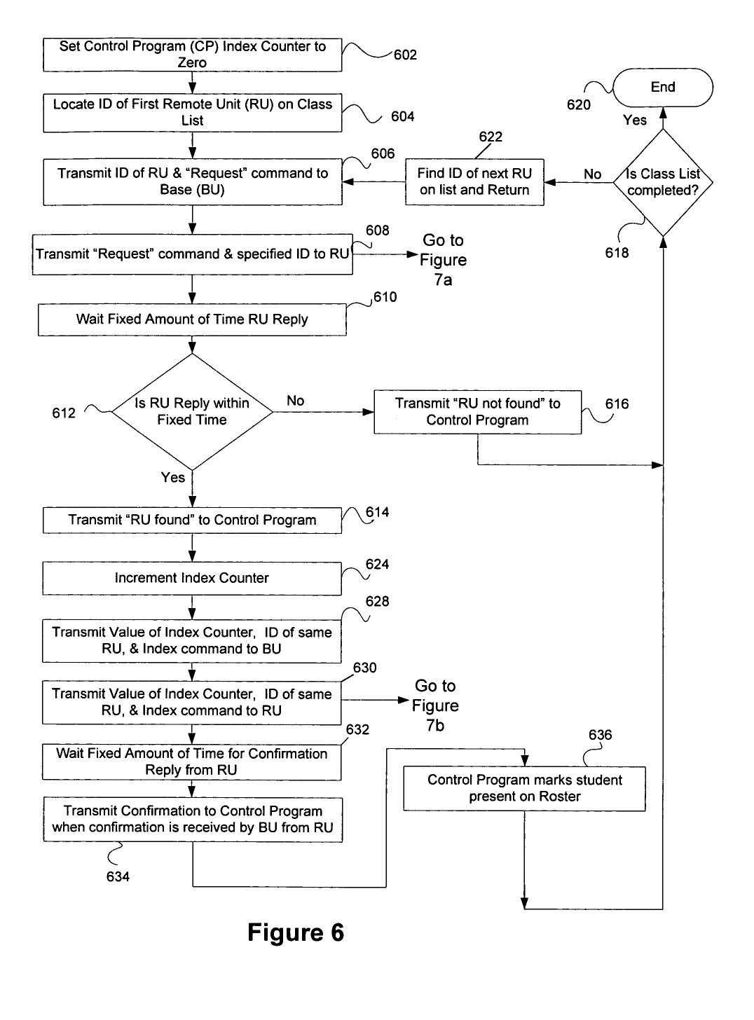

FIG. 5 depicts another timeline for another time-slice voting protocol in accordance with an aspect of the present invention. An aspect of the time-slice voting protocols of the current invention is that time-slice voting may reduce bandwidth and background as a base unit 102 may be listening during a very specific window. This may reduce transmission traffic and reduce the probability that random fluctuations could be interpreted as real messages.

Referring to FIG. 5, in a classroom there may be N active students each having a remote unit 104. The attendance procedures discussed above may ensure that each such remote unit 104 is assigned an index number which may be an integer value between 1 and N. In an alternative embodiment each of the remote units may also receive a group number along with an index number. The group number may classify each of the remote units into groups of approximately 100 to 200 remote units so that no remote unit 104 has to wait too long for a timing pulse. Those skilled in the art will realize that number of remote units comprising a group may be increased or decreased in accordance with various aspects of the invention.

During attendance, a control program 108 may assemble a list that correlates the index numbers with the actual ID of remote units 104. Each of the remote units 104 may store its own unique index number in its memory. Base unit 102 and each of the remote units 104 may also be aware of a predetermined constant SLICE_WIDTH 400. The SLICE_WIDTH 400 may be a length of time allotted to each remote unit 104 to send the remote unit's voting information to base unit 102. The SLICE_WIDTH 400 may provide enough information for each of the remote units 104 and base unit 102 to know exactly when to transmit or receive information from each student.

The transmission timeline 502 of FIG. 5 may indicate when either remote units 104 or base unit 102 are transmitting data as a function of time during the voting operation. For example, the process may begin when base unit 102 transmits a command to each of the remote units 104 in succession. For example, base unit 102 may first transmit a command to a first remote unit 104 (RU#1) as shown in transmission time line 502. After a delay of “Slice Width” 506, base unit 102 may transmit a command to a second remote unit (RU#2). This process may continue until base unit 102 has transmitted a command to each of the remote units 104 (RU#N) 507.

Upon receipt of a command from base unit 102, each remote unit 104 may wait the same amount of fixed time “RU_DELAY” 508 and then transmit its voting information back to the base unit as illustrated in FIG. 5.

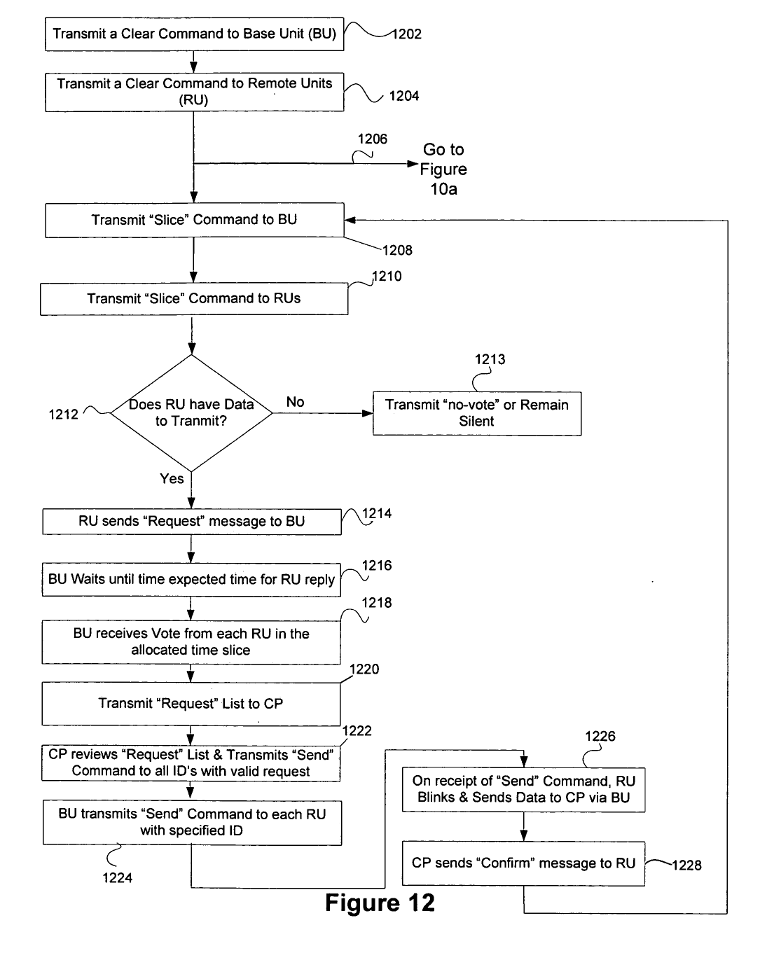

FIG. 11 depicts a flow diagram of a time-slice voting protocol of FIG. 5. In FIG. 11, a control program 108 may transmit a “clear” command to base unit 102 in step 1102. Upon receipt of the “clear” command, a base unit 102 in step 1104 may transmit to all of the remote units 104 simultaneously the “clear” command.

Upon receipt of the “clear” command at each of the remote units 104 (step 1002 FIG. 10a), the remote units 104 may clear their vote registers (step 1004). Each of the remote units 104 may flash an LED on its housing to indicate to a student that the remote units 104 have received a command from base unit 102 (step 1006).

In step 1108, control program 108 may transmit a “Slice” command to base unit 102. The base unit, in response to the “Slice” command in step 1110 may serially loop over all valid remote units 104 and transmit the “Slice” command to each of the remote units 104. The base unit 102 may issue the “Slice” command to each of the remote units 104 at a SLICE_WIDTH time interval. On receipt of the “Slice” command each of the remote units 104 may wait a fixed amount of time which may be greater than the number of students in the class time SLICE_WIDTH before transmitting the contents of their voting register (step 1112). In step 1114, remote units 104 may transmit the contents of their voting register to base unit 102.

In step 1116, base unit 102 may wait to receive a response from the first remote unit 104 until the time at which the reply from the first remote unit 104 is expected. The base unit 102 may listen for a time SLICE_WIDTH for each of the remote units 104, receiving from each of the remote units 104 content of their voting registers at the allocated time slice. In step 1118, base unit 102 transmits the information to control program 108.

In step 1120, control program 108 reviews the votes and in step 1120 transmits a “Confirm” command back to base unit 102 for each remote unit 104 that registered a valid vote. Base unit 102 in step 1124 transmits the “Confirm” command back to the remote units 104. In alternative embodiment the base unit 102 may immediately confirm to each of the remote units upon receipt of a valid message. In this manner, a remote may know when to expect a message from the base which may reduce bandwidth and the opportunity for fake messages.

Upon receipt of the “Confirm” command by a remote unit 104 in step 1008 in FIG. 10b, the remote unit 104 flashes an LED to indicate to the student that their vote has been received. In step 1126 the control program determines whether the voting time has expired. If the voting time has expired then voting is ended (step 1128). However, if the voting time has not expired, then the process continues in step 1108.

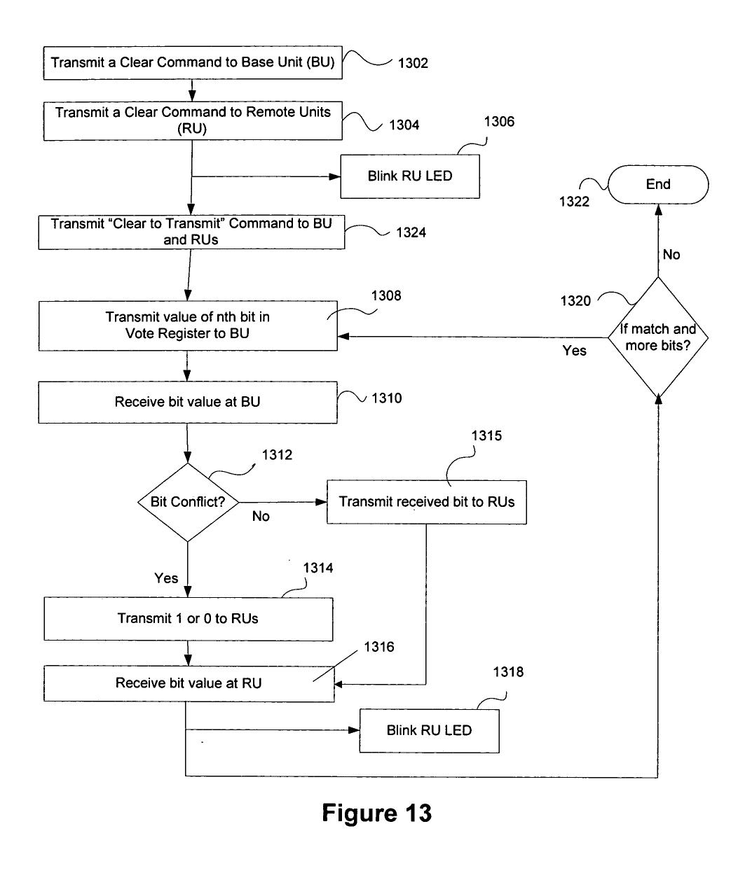

FIG. 12 depicts a flow diagram of another time-slice voting protocol according to another aspect of the present invention. The time-slice protocol in this aspect of the invention may be optimized for situations where the remote units 104 may have relatively large data packets or where the size of the data packet is unknown. In FIG. 12, a control program 108 may transmit a “clear” command to base unit 102 in step 1202. Upon receipt of the “clear” command, a base unit 102 in step 1204 may transmit to all of the remote units 104 simultaneously the “clear” command.

Upon receipt of the “clear” command at each of the remote units 104 (step 1002 FIG. 10a), the remote units 104 may clear their vote registers (step 1004). Each of the remote units 104 may flash an LED on its housing to indicate to a student that the remote units 104 have received a command from the base unit 102 (step 1006).

In step 1208, control program 108 may transmit a “Slice” command to base unit 102. Base unit 102, in response to the “Slice” command in step 1210 may transmit the “Slice” command to all of the remote units 104. On receipt of the “Slice” command each of the remote units 104 may determine in step 1212 whether the remote unit 104 has data to transmit. If the remote unit has data to transmit, then in step 1214 the remote unit 104 transmits a “request” message to base unit 102. If the remote unit does not have data to transmit as shown in step 1213 then the remote unit may either transmit a “no-vote” message, or remain silent. Both the transmission of a “no-vote” or the silence of a remote unit may indicate to base unit 102 that there is no change in the remote unit's vote.

In step 1216, base unit 102 may wait until the time at which the reply from the first remote unit 104 on the attendance list is expected. The amount of waiting time or delay time may be the value of a time SLICE_WIDTH for each remote unit 104. Base unit 102 may listen for a time SLICE_WIDTH for each remote unit 104 on a class list. Base unit 102 receives the vote from each of the remote units 104 during the allocated time slice in step 1218 and in step 1220 transmits the information to control program 108.

In step 1220, the retrieved list of “requests” is transmitted from base unit 102 to control program 108. Control program 108 in step 1222 may review the “requests” and transmit a “send” command to back to base unit 102. In step 1224, base unit 102 may transmit the “send” command to all of the remote units 104 that registered a valid “request.”

Upon receipt of the “send” command by a remote unit 104, the remote unit 104 transmits the data from its voting register to the base unit 102 and flashes an LED to indicate to a student that data has been transmitted to the base unit 102 in step 1226. The base unit 102 forwards the data from the voting register to the control program 108 which upon receipt transmits a “confirm” command to the remote units 1014 via the base unit 102 (step 1228). The control program 108 repeats the process starting at step 1208 until the voting time has expired.

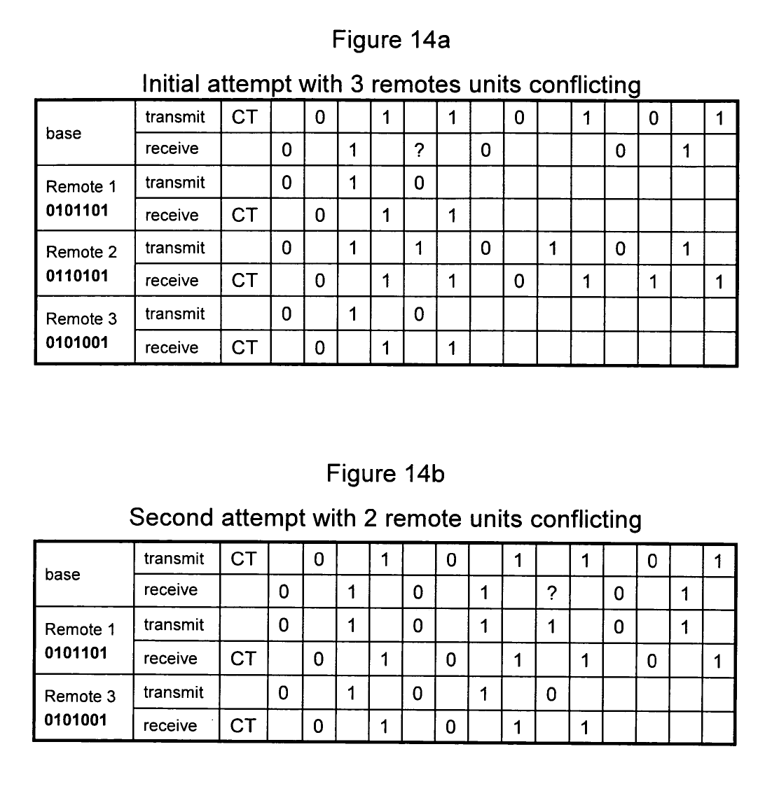

FIG. 13 depicts a flow diagram of another voting protocol according to another aspect of the present invention. The protocol in this aspect of the invention may be optimized for various situations. For example, the protocol in this aspect of the invention may be optimized for situations where the remote units 104 may have relatively large data packets or where the size of the data packet is unknown. In another example, the protocol in this aspect of the invention may be modified for when the total bandwidth of data to be transferred is relatively small and the data is entered onto the remote units asynchronously and at unpredictable times. It may offer full-duplex like transmission capabilities. Various aspects of the invention reduce the typical response time between when the user presses a button on a remote unit 102, and when the message is transmitted and confirmed. With various other protocols the typical response time is proportional to the total number of registered remote units 102. With various aspects of this protocol, the response time is proportional to the number of remote units 102 that have voted in the same time interval (which may be approximately 100 times faster in some cases).

In step 1302, a control program 108 may transmit a “clear” command to base unit 102. Upon receipt of the “clear” command, a base unit 102 in step 1304 may transmit to all of the remote units 104 simultaneously the “clear” command. Upon receipt of a “clear” command (or similar signal), the remote units 104 may blink an indication (e.g., an LED) in step 1306. The remote units 104 may also clear their vote registers.

In step 1324, control program 108 may transmit a “Clear to Transmit” command to base unit 102. Base unit 102, in response to the “Clear to Transmit” command in step 1324 may transmit to all of the remote units 104 simultaneously. On receipt of the “Clear to Transmit” command, each of the remote units 104 may send the contents of their voting register and their unique ID. One skilled in the art will appreciate that although the “Clear to Transmit” command is used in this example, other commands could be used to achieve similar results. In one example, a base unit 102 may send a synchronization signal and the remote units 104 initiate a transmission after the synchronization.

In step 1308 the remote units 104 transmit the first bit (e.g., “0”) from a voting register to the base unit 102. The base unit 102 receives all the transmitted bits in step 1310 and transmits back either a “0” or “1” in step 1314. The value the base unit 102 transmits to the remote units 104 may depend on whether the bits received at the base unit 102 were conflicting (as shown in step 1312.) If there was no conflict, then the base unit 102 may transmit the received bit value (in step 1315).

In step 1320, if the bit received matches the bit transmitted by that remote unit 104 and there are bits remaining in the Voting Register, then that remote unit 104 may transmit the next bit after the nth bit. If the bit received does not match the bit transmitted by that remote unit 104, then that remote unit 104 will end transmission of bits (in step 1322) and wait for a “Clear to Transmit” command before restarting transmission of bits from the first bit. One skilled in the art will appreciate that remote units 104 may be configured to wait for a predetermined time interval before restarting transmission of bits. At least one benefit of such an approach is a reduction in the number of transmission of the “Clear to Transmit” command (or similar commands) required.

If the remote unit successfully transmits all of its bits, it can flash an LED (or other indication) in step 1318 to confirm successful transmission and then may go into a “wait” mode until it receives more data from the user (e.g. a button is pressed). Various aspects of the invention may provide for the remote unit to transmit an unique identifier to the base unit (in step 1322) after successfully transmitting all bits in a voting register.

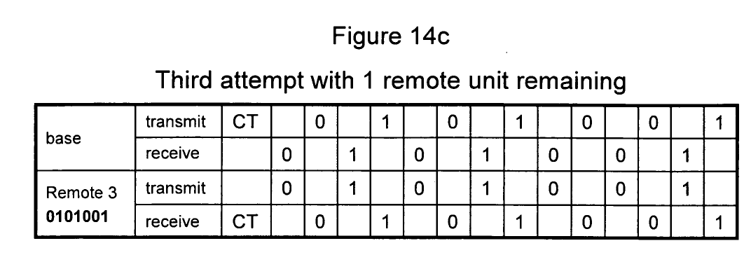

FIGS. 14 shows just one example of the bits sent and received by a base unit 102 and remote units 104 attempting to communicate at the same time. Each remote unit 104 waits for the “Clear to Transmit” command (depicted as “CT” in FIG. 14a) from the base unit 102. Each remote unit 104 then transmits the first bit (i.e., transmitted bit value) to the base unit 102. In FIG. 14a, if all remote units 104 are transmitting a first bit of “0”, the base unit 102 receives a “0” and transmits at “0” back. All remote units 104 receive the “0” (i.e., received bit value) confirming their first bit was successfully received. All remote units 104 proceed to transmit their second bit (e.g., “1”). The base unit 102 will receive the “1” and transmit a “1” back. All remote units 104 receive this “1”, confirming their second bit was received. They proceed to send their third bit.

For example, if a first remote unit 104 (“Remote 1” in FIG. 14a) and a second remote unit 104 (“Remote 3” in FIG. 14a) transmit a “0” and third remote unit 104 (“Remote 2” in FIG. 14a) transmits a “1”. The conflicting bits would create an invalid condition (denoted by a “?” in FIG. 14) at the base unit 102, and the base unit 102 then may choose to respond with either a 0 or 1. In this case it sets bit three to “1” and transmits a “1” to the remote units 104. The first remote unit 104 (“Remote 1” in FIG. 14a) and third remote unit 104 (“Remote 3” in FIG. 14a) determine that their third bit was not received, so they wait for the next “Clear to Transmit” message at which point each may attempt to resend it's entire message in a similar fashion. Meanwhile, the second remote unit 104 (“Remote 2” in FIG. 14a) determines that its third bit was received and continues to send its fourth bit. Since it is the only remaining remote unit 102 transmitting, each bit will be confirmed and it will complete transmission of its message.

In FIG. 14b, a base unit 104 may send out another “Clear to Transmit” command after finishing receipt of the message from the second remote unit 102 (“Remote 2” in FIG. 14a). This time the first remote unit 102 (“Remote 1” in FIG. 14b) and third remote unit 102 (“Remote 3” in FIG. 14b) will respond. They will each get confirmations through bit 4 (i.e., the bits transmitted do not create a conflict at the base unit), at which point the third remote unit 102 will drop out, and the first remote unit 102 will complete its transmission. The base unit 104 will then send another “Clear to Transmit” message, and the third remote unit will successfully transmit its message, as depicted in FIG. 14c.

Various aspects of the present invention include the ability of the base unit 104 to determine if a bit is valid. This is facilitated by ensuring that the remote units 102 all begin their transmission at substantially the same time (or within a small fraction of the time to transmit a single bit.) For example, this might be achieved by having the base unit 104 send the “Clear to Transmit” command (or a synchronization signal with the remote units 102 only initiating a transmission at fixed time intervals after the synchronization.) This time interval might be set according to the time necessary to send a complete message from a remote unit 102. Thus, if a remote unit 102 terminated its transmission due to an invalid confirmation, it would not need to wait for another “Clear to Transmit” message, but could start sending at the next interval (i.e., cycle.) At least one advantage is that it reduces the number of “Clear to Transmit” messages which must be sent.

The present invention has been described in terms of preferred and exemplary embodiments thereof. Numerous other embodiments, modifications and variations within the scope and spirit of the appended claims will occur to persons of ordinary skill in the art from a review of this disclosure.

1. A system for the two-way communication of vote information, said system comprising of:
a. a host computer communicating information to a base unit, wherein said host computer includes a control program;
b. said base unit communicating information to said host computer and to at least one remote unit, wherein said base unit comprises:
i. a transmitter module for transmitting information to a remote unit;
ii. a receiver module for receiving information transmitted from a remote unit;
iii. a microcontroller for implementing commands received from a host computer and for supporting information used by said transmitter module or said receiver module; and
c. said at least one remote unit communicating information to said base unit, wherein said remote unit comprises:
i. a transmitter module for transmitting information to a base unit;
ii. a receiver module for receiving information transmitted from a base unit;
iii. a microcontroller for implementing commands received from a base unit and for supporting information used by the remote unit;
iv. memory for storing information generated by a user and information transmitted from a base unit;
v. a visual indicator for displaying status information to a user;

2. The system of claim 1, wherein each remote unit of at least one remote unit corresponds to an unique identifier.

3. The system of claim 1, wherein said base unit and host computer are housed inside the same physical structure.

4. The system of claim 1, wherein said host computer includes a storage of student information.

5. The system of claim 1, further comprising a server computer communicating with said host computer, and said server computer includes a database of student information.

6. A base unit for the two-way communication of information, said base unit comprising:
a. a transmitter module for transmitting information to a remote unit;
b. a receiver module for receiving information transmitted from a remote unit;
c. a microcontroller for implementing commands received from a host computer interface module and for supporting information used by said transmitter module or said receiver module; and
d. a host computer interface module for communicating with said microcontroller and a host computer.

7. The base unit of claim 6, wherein said transmitter module communicates using RF communications.

8. The base unit of claim 6, wherein said host computer interface module is an USB port.

9. A remote unit for the two-way communication of information, said remote unit comprising:
a. a transmitter module for transmitting information to a base unit;
b. a receiver module for receiving information transmitted from a base unit;
c. a microcontroller for implementing commands received from a base unit and for supporting information used by the remote unit;
d. memory for storing information generated by a user and information transmitted from a base unit; and
e. a visual indicator for displaying status information to a user.

10. The remote unit of claim 9, wherein said memory is a voting register.

11. The remote unit of claim 9, wherein said visual indicator is a LED and said status information includes indications that information has been transmitted by said transmitter module, indications that communication with a base unit has been established, and indications that a command from a base unit has been received.

12. The remote unit of claim 9, further comprising a counter for indicating to said microcontroller when a predetermined amount of time has elapsed.

13. The remote unit of claim 9, wherein said transmitter module communicates using RF communications.

14. The remote unit of claim 9, wherein said information stored in said memory is comprised of an index counter value and a predetermined length of time for said remote unit to transmit voting information.

15. A method for taking attendance using a control program, comprising the steps of:
a. transmitting data to a transmitter module in a base unit for transmission to a remote unit;
b. receiving first information from said base unit relating to the status of said remote unit;
c. processing said first information from said base unit and updating an index counter for tracking the number of remote units;
d. transmitting an index counter, some identification information, and an index command to a transmitter module in a base unit for transmission to said remote unit; and
e. receiving second information from said base unit confirming the status of said remote unit.

16. The method of claim 15, wherein said data of said step of transmitting data to a transmitter module in a base unit for transmission to a remote unit is comprised of a request command and identification information including an identifier unique to each remote unit corresponding to a user.

17. The method of claim 15, wherein said data of said step of transmitting data to a transmitter module in a base unit for transmission to a remote unit is comprised of a login key.

18. The method of claim 17, further comprising the step of comparing said login key with the key of a remote unit.

19. The method of claim 18, wherein at least some of said control program is located in said base unit.

20. The method of claim 17, further comprising the step of repeating step a to step e and said step of comparing said login key, until the login command is terminated.

21. The method of claim 15, wherein said first information from said base unit includes a command indicating that a remote unit was found or that a remote unit was not found.

22. The method of claim 15, wherein said second information from said base unit includes a command confirming that said remote unit has been recognized.

23. The method of claim 15, further comprising the step of processing said second information and updating a student roster.

24. The method of claim 15, further comprising the step of configuring said base unit to wait a predetermined amount of time for communication from said remote unit.

25. The method of claim 15, further comprising the step of repeating step a to step e while unconfirmed users remains on a student roster.

26. The method of claim 15, wherein said index counter is comprised of an index number and a group number.

27. A method for operating a base unit used for two-way communication of information between a plurality of remote units and said base unit, the steps comprising of:
a. transmitting a synchronization command from a base unit to a plurality of remote units;
b. simultaneously receiving at said base unit bit values from a plurality of remote units, wherein each remote unit of said plurality of remote units is transmitting the same nth bit of a voting register;
c. selecting one of said bit values from said plurality of remote units as a received bit value, if said bit values from said plurality of remote units are not equal; and
d. transmitting said received bit value from said base unit to said plurality of remote units.

28. The method of claim 27, wherein step b to step d are performed for each bit in a n-bit voting register.

29. The method of claim 27, further comprising the step of receiving an unique identifier from said remote unit of said plurality of remote units after transmitting said received bit for the last bit in a voting register.

30. A method for operating a remote unit used for communicating information between a plurality of remote units and a base unit, the steps comprising of:
a. receiving a synchronization command from a base unit;
b. transmitting the value of the nth bit of a voting register to said base unit, wherein said bit value is a transmitted bit value;
c. receiving a bit value from said base unit, wherein said bit value is a received bit value; and
d. comparing said received bit value to said transmitted bit value to determine whether said transmitted bit value was successfully received by said base unit.

31. The method of claim 30, further comprising the step of repeating step b to step d for each bit in a n-bit voting register while said transmitted bit value is successfully received by said base unit.

32. The method of claim 30, further comprising the step of transmitting an unique identifier to said base unit after successfully transmitting all bits in said voting register.

33. The method of claim 30, wherein said step of transmitting the value of the nth bit of a voting register is done at a fixed time after said step of receiving a synchronization command.

34. A method for communicating vote information to and from a remote unit, the steps comprising of:
a. receiving a clear command at a remote unit;
b. receiving a slice command at said remote unit;
c. transmitting vote information from said remote unit to a base unit; and
d. receiving a confirmation command at said remote unit.

35. The method of claim 34, wherein said step of transmitting vote information further comprises:
e. transmitting the value of the nth bit of a voting register to said base unit, wherein said bit value is a transmitted bit value;
f. receiving a bit value from said base unit, wherein said bit value is a received bit value; and
g. comparing said received bit value to said transmitted bit value to determine whether said transmitted bit value was successfully received by said base unit.

36. The method of claim 35, wherein said step e to step g are performed for every bit of a voting register in a remote unit, until said base unit does not successfully accept a transmitted nth bit.

37. The method of claim 34, further comprising the step of clearing the contents of a vote register in said remote unit in response to receiving said clear command.

38. The method of claim 34, wherein said vote information is comprised of at least some of the contents of a vote register located on said remote unit.

39. The method of claim 38, wherein said vote information does not include an unique identifier corresponding to said remote unit.

40. The method of claim 34, wherein the step of transmitting vote information is done after waiting a fixed amount of time.

41. The method of claim 40, wherein said fixed amount of time is determined using an unique index counter value corresponding to said remote unit.

42. The method of claim 34, further comprising the step of activating a visual indicator on said remote unit in response to receiving a command at said remote unit from said base unit.

43. The method of claim 42, wherein said visual indicator is a LED.

44. The method of claim 34, further comprising the step of repeating step b to step d until voting time expires.

45. The method of claim 34, further comprising the step of transmitting a request command to said base station after said step of receiving a slice command, when vote information is present on said remote unit.

46. The method of claim 45, wherein said step of transmitting vote information occurs after the additional step of receiving a send command at said remote unit.

47. The method of claim 34, further comprising the step of transmitting a no-vote command to a base station after said step of receiving a slice command, when no vote information is to be transmitted from said remote unit.

48. The method of claim 28, wherein step b to step d are performed for each bit in a n-bit voting register for a plurality of cycles, wherein a cycle starts at a fixed time interval after said step of transmitting a synchronization command.

49. The base unit of claim 6, further comprising a display for displaying information to a user of said base unit.

50. The base unit of claim 49, further comprising buttons for inputting data into said base unit for controlling the operation of said base unit.
